(19) United States
(12) Patent Application Publication
(10) Pub. No.: US 2025/0307752 A1
(43) Pub. Date: Oct. 2, 2025

(54) QUESTION GENERATION TO FACILITATE INTERPRETATION OF INFERENCE MODEL OUTPUTS

(71) Applicant: Dell Products L.P., Round Rock, TX (US)

(72) Inventors: LEV MAKLER, Be'er Sheva (IL); OFIR EZRIELEV, Be'er Sheva (IL); ANAT PARUSH TZUR, Tel Aviv (IL); AMIHAI SAVIR, Newton, MA (US)

(21) Appl. No.: 18/622,068

(22) Filed: Mar. 29, 2024

(51) Int. Cl. G06Q 10/0637

(52) U.S. Cl. CPC G06Q 10/06375

(57) ABSTRACT

Methods and systems for interpreting outputs from inference models are disclosed. To establish a level of confidence in the outputs, ingest data utilized by the inference models to generate the outputs may be investigated. To efficiently investigate ingest data to identify portions of the ingest data that had a highest contribution to generation of the outputs, a first large language model (LLM) may ingest the output, the ingest data, and a set of queries to be answered by the first LLM. The first LLM may generate leading indicators and emerging trends for a portion of the outputs. The leading indicators, the emerging trends, and a set of question generation templates may be fed into a second LLM to generate one or more questions. The one or more questions may be usable to establish a level of confidence in the outputs.

### FIELD

Embodiments disclosed herein relate generally to interpreting inference model outputs. More particularly, embodiments disclosed herein relate to systems and methods to facilitate interpretation of inference model outputs using questions generated based on at least the inference model outputs.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show data flow diagrams illustrating generation of questions usable to interpret an inference model output in accordance with an embodiment.

FIG. 3 shows a flow diagram illustrating a method of generating questions usable to interpret an inference model output in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for interpreting inference model outputs. An inference model may generate outputs (e.g., inferences, predictions) by ingesting input data from any number of data sources and may provide the outputs to any number of downstream consumers. The downstream consumers may provide computer-implemented services and/or make decisions based on the outputs.

Prior to making the decisions and/or providing the computer-implemented services, the downstream consumers may establish a level of confidence in each output of the outputs. The level of confidence may determine, at least in part, whether the downstream consumer utilizes the outputs as a basis for making decisions and/or providing the computer-implemented services.

To establish the level of confidence, input data (and/or data sources that provided the input data) ingested by the inference model to generate the output may be evaluated. Evaluating the input data may include identifying portions of the input data (e.g., particular data sources from which the input data was obtained, particular types of the input data) that made largest contributions to generation of the outputs by the inference model. Those portions of the input data may be further examined and/or analyzed to establish a quality of the data and/or data source, a reliability of the data and/or data source, etc.

However, evaluating the input data may require a subject matter expert (SME) (e.g., a downstream consumer) to manually examine and/or analyze the input data. Manual examination of the input data may be a time-intensive process, may place an undesirable cognitive burden on the downstream consumer, and/or may otherwise consume an undesirable quantity of resources of the downstream consumer that may otherwise be allocated by providing the computer-implemented services to consumers of the computer-implemented services.

In addition, manual and/or partially manual evaluations of the input data performed by the downstream consumer may be vulnerable to human error which may lead to, for example, an output of the outputs being assigned a higher level of confidence or a lower level of confidence than warranted based on any criteria for assigning levels of confidence. Assigning inappropriate levels of confidence to outputs may lead to decisions being made based on less reliable predictions which may, therefore, negatively impact an availability and/or quality of the computer-implemented services.

To evaluate the input data without user (e.g., downstream consumer) intervention, a first large language model (LLM) may attempt to answer a set of queries related to the outputs by ingesting: (i) the outputs, (ii) the input data, (iii) the set of queries, and/or (iv) other data usable to evaluate the input data.

For example, the output may include a first prediction. A first query of the set of queries may prompt the first LLM to identify leading indicators for the first prediction. The first LLM may ingest at least the first prediction and the input data that was used to generate the prediction to identify portions of the ingest data that were most impactful in generating the first prediction (e.g., the leading indicators). Additional queries of the set of queries may prompt the first LLM to identify other portions of the input data such as emerging trends corresponding to the leading indicators.

Following answering each query of the set of queries, a second LLM may ingest at least the responses generated by the first LLM (e.g., leading indicators and emerging trends for the output) to generate one or more questions. The one or more questions may be usable by a downstream consumer to search data sources from which the inference model ingest data was obtained for additional data usable to establish the level of confidence in the output.

Thus, embodiments disclosed herein may provide an improved system for interpreting outputs from inference models. By utilizing the first LLM to identify portions of the input data that contributed most highly to generation of an inference model output, a downstream consumer may more efficiently determine a level of confidence in the output. In addition, the second LLM may generate questions regarding the portions of the input data to guide downstream consumers when establishing the level of confidence. By doing so, downstream consumers may more efficiently determine whether predictions are to be used as a basis for providing computer-implemented services which may, therefore, increase a quality and a reliability of the computer-implemented services.

In an embodiment, a method for interpreting an output generated by an inference model is provided. The method may include: obtaining, based on at least the output, analytic data generated by a first large language model (LLM), the analytic data comprising: leading indicators from ingest data used by the inference model to generate the output; and/or emerging trends from the ingest data used by the inference model to identify the leading indicators; obtaining, using at least the analytic data and a set of question generation templates, one or more questions generated by a second LLM, the one or more questions being usable to interpret the output; and providing the one or more questions to a downstream consumer for use in interpreting the output.

Obtaining the analytic data may include: feeding first ingest data into the first LLM, the first ingest data comprising: inference model ingest data used by the inference model to generate the output; the output; and a set of queries comprising questions to be answered by the first LLM, the questions being based on the inference model ingest data and the output; and obtaining, as output from the first LLM, the analytic data.

The leading indicators may be based on a first query of the set of the queries and the emerging trends may be based on a second query of the set of the queries.

The first query and the second query may be keyed to a portion of the output.

The output may include a prediction for a condition impacting a business at a future point in time.

The condition impacting the business at the future point in time may be a change in availability of supply of a product from a supplier.

A leading indicator of the leading indicators may be revenue of the supplier at the future point in time.

An emerging trend of the emerging trends may be a change in the revenue of the supplier at the future point in time.

The one or more questions may be usable to search data sources from which the inference model ingest data was obtained to identify additional data usable to establish a level of confidence in the output.

A first question generation template of the set of the question generation templates may be keyed to a first portion of the analytic data, the first portion of the analytic data including an indicator of the indicators and an emerging trend of the emerging trends.

The first question generation template may prompt the second LLM to generate a question usable to identify facts to establish a causal relationship between a portion of the output and the first portion of the analytic data.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

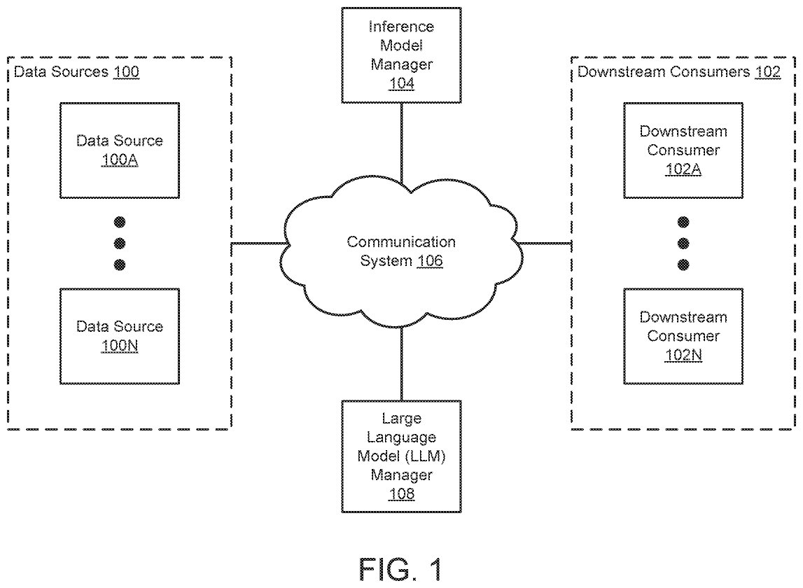

Turning to FIG. 1, a block diagram illustrating a system in accordance with an embodiment is shown. The system shown in FIG. 1 may provide computer-implemented services that may utilize inference models as part of the provided computer-implemented services.

The inference models may be artificial intelligence (AI) models and may include, for example, linear regression models, deep neural network models, and/or other types of inference generation models. The inference models may be used for various purposes. For example, the inference models may be trained to recognize patterns, automate tasks, and/or make decisions.

The computer-implemented services may include any type and quantity of computer-implemented services. The computer-implemented services may be provided by, for example, data sources 100, inference model manager 104, downstream consumers 102, LLM manager 108, and/or any other type of devices (not shown in FIG. 1). Any of the computer-implemented services may be performed, at least in part, using inference models and/or inferences obtained with the inference models.

Data sources 100 may include any number of data sources (100A-100N) that may obtain (i) training data usable to train inference models, and/or (ii) ingest data that is ingestible into trained inference models to obtain corresponding inferences. The inferences generated by the inference models may be provided to downstream consumers 102 for downstream use.

Downstream consumers 102 may include any number of data processing systems (e.g., devices) that a user may utilize to provide, all or a portion, of the computer-implemented services. When doing so, downstream consumers 102 may consume inferences obtained by inference model manager 104 (and/or other entities using inference models managed by inference model manager 104).

However, if inferences from inference models are unreliable (e.g., of poor quality, based on unreliable data), downstream consumers 102 may be unable to provide, at least in part, the computer-implemented services, may provide less desirable computer-implemented services, and/or may otherwise be impacted in an undesirable manner.

To increase a likelihood of reliably providing the computer-implemented services, downstream consumers 102 may establish a level of confidence in an output (e.g., an inference, a prediction) from an inference model. To do so, a subject matter expert (SME) and/or other user (e.g., of one or more of downstream consumers 102) may analyze inference model ingest data (e.g., data from data sources 100 used by the inference model to generate the output) to identify one or more leading indicators and/or one or more emerging trends.

A leading indicator may be data source, a type of data, and/or any other element of the inference model ingest data that strongly contributed (e.g., based on any criteria and/or based on any threshold for levels of contribution) to generation of the output by the inference model. An emerging trend may include a portion of the inference model ingest data corresponding to the leading indicator.

For example, a leading indicator may be a first type of data obtained from a first data source. The first type of the data may be revenue of a supplier of a product at a future point in time. The emerging trend may include, for example, a portion of the ingest data indicating a change in the revenue of the supplier at the future point in time.

However, analyzing the inference model ingest data to identify the leading indicators and emerging trends may be performed manually (e.g., fully manually, partially manually) by users of downstream consumers 102 and, therefore, may be vulnerable to human error. In addition, analyzing the ingest data may consume an undesirable quantity of resources (e.g., time resources, computing resources, cognitive resources) that may otherwise be allocated to providing the computer-implemented services.

For example, prior to making decisions and/or providing the computer-implemented services based on the outputs, downstream consumer 102A may establish a level of confidence in the outputs. Establishing the levels of confidence may be vulnerable to human error and/or delays may occur during establishment of the levels of confidence that may negatively impact an availability and/or a quality of the computer-implemented services.

In general, embodiments disclosed herein may provide methods, systems, and/or devices for facilitating interpretation of inference model outputs so that confidence levels in the outputs may be more efficiently obtained. By doing so, the system may be more likely to provide desired computer-implemented services due to an increased likelihood of efficiently identifying outputs (e.g., predictions) that meet confidence level expectations.

To facilitate interpretation of inference model outputs, the system of FIG. 1 may: (i) obtain an output generated by an inference model (e.g., managed by inference model manager 104), (ii) obtain, based at least on the output, analytic data generated by the first LLM, (iii) obtain, using at least the analytic data and a set of question generation templates, one or more questions generated by a second LLM, and/or (iv) provide the one or more questions to a downstream consumer for use in interpreting the output.

To obtain inference model outputs, any number of inference models may be managed by inference model manager 104. To do so, inference model manager 104 may: (i) oversee training processes to obtain trained inference models, (ii) manage inference model repositories, (iii) oversee inference generation by the inference models, (iv) perform remedial actions when one or more inference models does not perform as expected, and/or (v) perform other actions. Consequently, outputs generated by the any number of the inference models may be collected by inference model manager 104 and may be provided to other entities (e.g., downstream consumers 102) for use in performing the computer-implemented services.

To obtain the analytic data generated by the first LLM, the first LLM may be managed by LLM manager 108. LLM manager 108 may host and operate any number of LLMS.

The analytic data generated by the first LLM may include (for each output generated by the inference model): (i) leading indicators from ingest data used by the inference model to generate the output, and/or (ii) emerging trends from the ingest data used by the inference model to identify the leading indicators.

To generate the analytic data, the first LLM may ingest first ingest data and generate the analytic data as output. The first ingest data may include: (i) inference model ingest data used by the inference model to generate the output, (ii) the output, and/or (iii) a set of queries including questions to be answered by the first LLM, the questions being based on the inference model ingest data and the output.

The analytic data, the set of question generation templates, and/or other data may be fed into the second LLM to generate the one or more questions. A first question generation template of the set of question generation templates may, for example, prompt the second LLM to generate a question usable to identify facts to establish a causal relationship between a portion of the output and a portion of the analytic data.

Consider a scenario in which the inference model is trained to predict availability of supply of a product from a supplier at a future point in time. The inference model ingest data may include historical data regarding supply of the product from the supplier, forecasted data related to revenue and/or sales by the supplier, and/or other data. The output (e.g., a prediction of the availability of the supply of the product from the supplier), the inference model ingest data, a set of queries and/or other data may be fed into the first LLM.

The first LLM may generate a list of leading indicators and a list of emerging trends corresponding to each leading indicator of the list of the leading indicators. For example, a leading indicator of the list of the leading indicators may be revenue of the supplier at the future point in time. Similarly, an emerging trend of the emerging trends may be a change in the revenue of the supplier at the future point in time.

The second LLM may ingest the leading indicators, the emerging trends, and the question generation templates to generate one or more questions. The questions may help guide a downstream consumer to establish a level of confidence in the output.

To perform the above-mentioned functionality, the system of FIG. 1 may include data sources 100, inference model manager 104, downstream consumers 102, LLM manager 108, and/or other entities. Data sources 100, downstream consumers 102, inference model manager 104, LLM manager 108, and/or any other type of devices not shown in FIG. 1 may perform all, or a portion of the computer-implemented services independently and/or cooperatively.

Data sources 100 may include any number and/or type of data sources. Data sources 100 may include, for example, data collectors, data aggregators, data repositories, and/or any other entity responsible for providing input data to inference models, LLMs, etc.

Inference model manager 104 may include any number of devices (e.g., data processing systems) and may be responsible for managing any number of inference models. Inference model manager 104 may: (i) host and operate the inference models, (ii) obtain outputs from the inference models, and/or (iii) provide the outputs to another entity responsible for establishing levels of confidence in the outputs.

Downstream consumers 102 may provide, all or a portion, of the computer-implemented services. When doing so, downstream consumers 102 may obtain outputs obtained by inference model manager 104 (and/or other entities using inference models managed by inference model manager 104). Downstream consumers 102 may be responsible for establishing levels of confidence in the outputs, and/or may determine whether the levels of confidence are sufficient (e.g., via comparison to a threshold) to perform computer-implemented services based on the outputs.

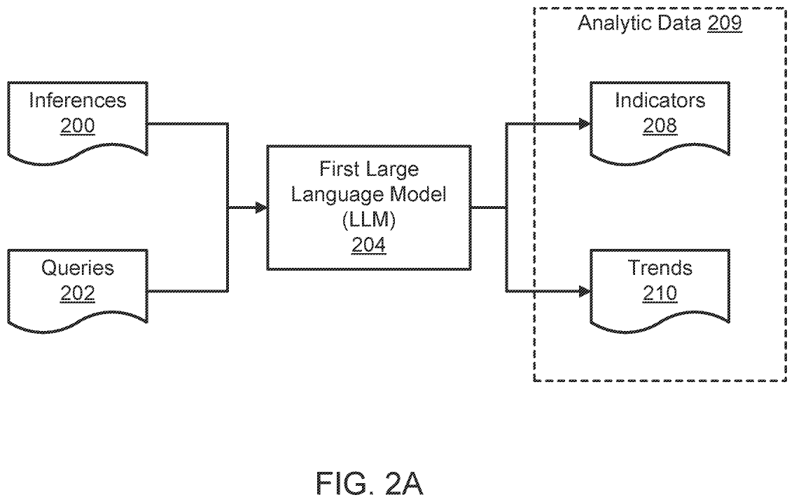

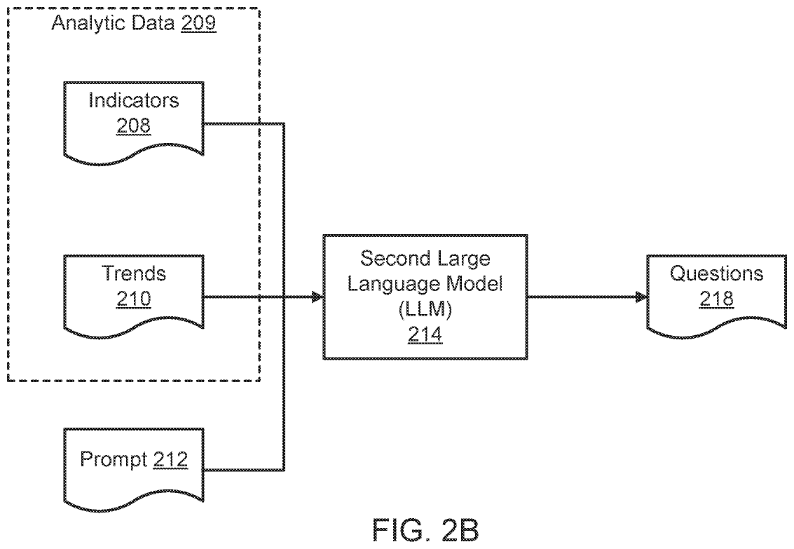

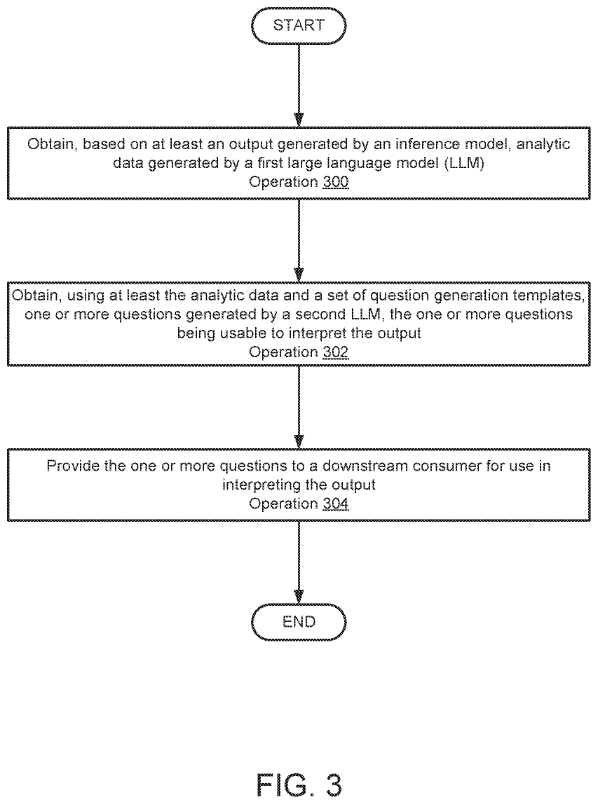

When performing its functionality, one or more of inference model manager 104, data sources 100, LLM manager 108, and downstream consumers 102 may perform all, or a portion, of the methods and/or actions shown in FIGS. 2A-3.

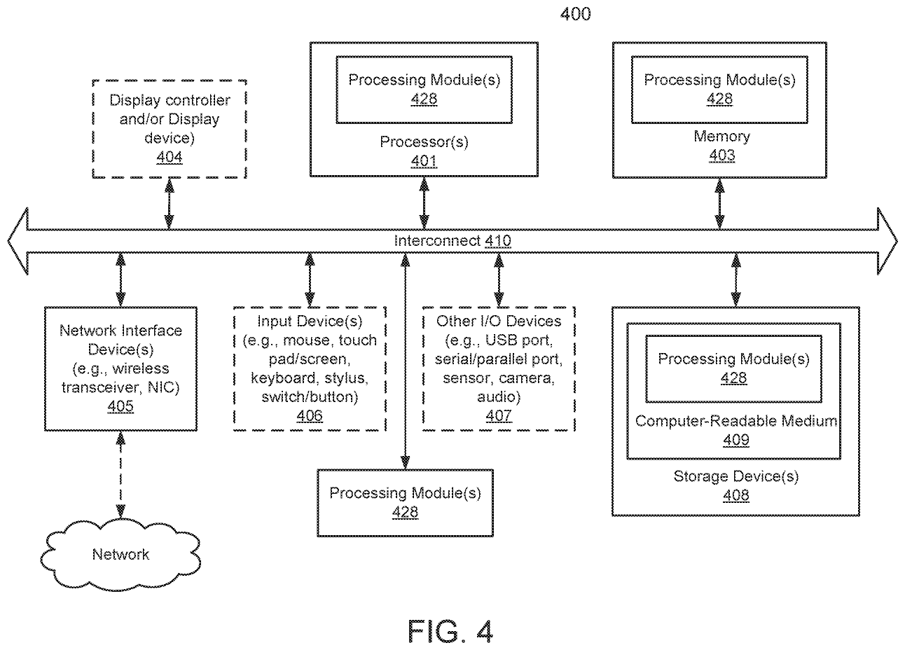

Any of inference model manager 104, data sources 100, LLM manager 108, and downstream consumers 102 may be implemented using a computing device (e.g., a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 106.

Communication system 106 may include one or more networks that facilitate communication between any number of components. The networks may include wired networks and/or wireless networks (e.g., and/or the Internet). The networks may operate in accordance with any number and types of communication protocols (e.g., such as the internet protocol).

Communication system 106 may be implemented with one or more local communications links (e.g., a bus interconnecting a processor of LLM manager 108 and any of the data sources 100, downstream consumers 102, and inference model manager 104).

While illustrated in FIG. 1 as included a limited number of specific components, a system in accordance with an embodiment may include fewer, additional, and/or different components than those illustrated therein.

The system described in FIG. 1 may be used to facilitate interpretation of outputs from inference models in order to improve availability and/or quality of computer-implemented services provided to consumers of the computer-implemented services. The following processes described in FIGS. 2A-2B may be performed by the system in FIG. 1 when providing this functionality.

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 200, 202, etc.) is used to represent data structures and a third set of shapes (e.g., 204, 214) is used to represent LLMs.

Turning to FIG. 2A, a first data flow diagram in accordance with an embodiment is shown. Consider a scenario in which an inference model is trained to generate outputs (e.g., inferences) to predict a condition impacting a business at a future point in time. The condition impacting the business at the future point in time may include, for example, a change in availability of supply of a product from a supplier.

Specifically, the business may purchase hardware components (e.g., hard drives, computer monitors) from the supplier and the change in the availability of the product may include a decrease in availability of hard drives for purchase by the business at the future point in time.

Inferences 200 may include any number of predictions (e.g., outputs) from the inference model, any amount of inference model ingest data used by the inference model to generate the outputs, and/or other data related to inference generation by the inference model.

Inferences 200, queries 202, and/or the other data may make up first ingest data for first LLM 204. The first ingest data may be fed into first LLM 204 to obtain analytic data 209 as output from first LLM 204.

Queries 202 may include questions to be answered by first LLM 204. The questions may be based on the inference model ingest data and the output. Each query (e.g., question) of queries 202 may be keyed to a portion of inferences 200 (e.g., the output from the inference model). Specifically, a first query may include a question intended to identify leading indicators for a first prediction included in the output a second query may include a question intended to identify emerging trends corresponding to the leading indicators. Additional queries may be included in queries 202 and may be keyed to other predictions included in the output.

For example, the first prediction may indicate, as previously mentioned, that an availability of hard drives for purchase by the business may decrease at the future point in time. A second prediction may indicate that a supply of computer monitors may increase at the future point in time. Therefore, the first query may be intended to identify leading indicators of the predicted decrease in hard drive availability. A third query may be intended to identify leading indicators of the predicted increase in computer monitor availability, etc.

First LLM 204 may be a language model (e.g., an artificial neural network) trained to generate language, understand language, and/or otherwise process requests related to languages. First LLM 204 may be trained using large training datasets to learn statistical relationships within text. First LLM 204 may be trained, for example, to analyze data included in inferences 200 to answer questions included in queries 202.

As previously mentioned, analytic data 209 may be obtained as an output from first LLM 204. Analytic data 209 may include indicators 208 and trends 210. Indicators 208 may include any number of leading indicators and each leading indicator of the leading indicators may be associated with a portion of inferences 200. For example, a first leading indicator may be generated in response to the first query and may identify a type of data and/or a particular data source that contributed most significantly (e.g., compared to a contribution made by other types of data and/or other data sources) to generation of the first prediction of inferences 200.

The first leading indicator may be revenue of the supplier (e.g., the hard drive supplier) at the future point in time. In other words, historical revenue trends for the supplier as well as forecasted future revenue for the supplier may have had the most impact on generation of the prediction that the supplier will experience a decrease in availability of hard drives at the future point in time.

Trends 210 may include any number of emerging trends from the ingest data used by the inference model to identify indicators 208. Each emerging trend of trends 210 may be associated with a portion of inferences 200. For example, a first emerging trend of trends 210 may represent a trend in data associated with the first leading indicator. Specifically, the first emerging trend may include data indicating a change in the revenue of the supplier of the hard drives at the future point in time. The first emerging trend may include data (e.g., historical and/or forecasted data) showing a decrease in revenue of the supplier over time.

By generating analytic data 209 automatically using first LLM 204, information indicating how the inference model generated predictions of inferences 200 may be more efficiently identified when compared to manual examination of inference model ingest data by a user.

Turning to FIG. 2B, a second data flow diagram in accordance with an embodiment is shown. To understand an impact of analytic data 209 on inference generation by the inference model, analytic data 209 and prompt 212 may be fed into second LLM 214 to obtain questions 218 as output from second LLM 214.

Prompt 212 may include a set of question generation templates. A first question generation template of the set of question generation templates may prompt second LLM 214 to generate a question usable to identify facts to establish a causal relationship between a prediction of inferences 200 (e.g., the first prediction that the supply of hard drives will decrease at the future point in time) and a first portion of analytic data 209 (e.g., indicators 208 and trends 210).

For example, the first question generation template may be keyed to indicator 208 and trend 210. The first question generation template may include information usable to generate a question intended to determine why a decrease in the revenue of the supplier at the future point in time (e.g., as indicated by indicator 208 and trend 210) may cause the supplier to experience a decrease in availability of hard drives (e.g., as indicated by a portion of inferences 200) at the future point in time.

Second LLM 214 may be a language model (e.g., an artificial neural network) trained to generate language, understand language, and/or otherwise process requests related to languages. Second LLM 214 may be trained using large training datasets to learn statistical relationships within text. Second LLM 214 may be trained, for example, to analyze data included in analytic data 209 to generate questions 218 based on prompt 212.

Questions 218 may include one or more questions usable to interpret the output included in inferences 200. The one or more questions included in questions 218 may be usable to search data sources (e.g., economic reports) from which the inference model ingest data was obtained to identify additional data usable to establish a level of confidence in the output.

The level of confidence in the output may be a quantification of a likelihood that the output is reliable and, therefore, useful for providing computer-implemented services. The level of confidence may be established based on any criteria and establishing the level of confidence may include determining, for example, whether a data source from which a leading indicator was obtained is a reliable data source.

A first question of questions 218, as previously mentioned, may be intended to determine why a decrease in the revenue of the supplier at the future point in time (e.g., as indicated by indicator 208 and trend 210) may cause the supplier to experience a decrease in availability of hard drives (e.g., as indicated by a portion of inferences 200) at the future point in time. Questions 218 may be provided to any entity responsible for identifying the level of confidence in inferences 200.

For example, a downstream consumer (e.g., 102A) may utilize the first question to further investigate data sources from which indicator 208 was obtained, other data available from the data sources from which the inference model input data was obtained, etc. Specifically, downstream consumer 102A may search the data sources for: (i) data indicating decreases in supply of other products as a result of a decrease in revenue, (ii) data indicating that the forecasted decrease in revenue disproportionally impacts hard drive production by the supplier, and/or (iii) other data related to the causal relationship between the portion of inferences 200 and the portion of analytic data 209.

By generating questions using the second LLM, levels of confidence in predictions generated by inference models may be more efficiently established and, subsequently, it may be determined whether the predictions are usable as a basis for providing computer-implemented services. Doing so may increase a likelihood of timely provision of the computer-implemented services and a likelihood of computer-implemented services being based on reliable predictions, which may increase a quality of the computer-implemented services for consumers of the computer-implemented services.

Any of the processes described may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes described may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to generate questions usable to interpret inference model outputs. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of generating questions usable to interpret inference model outputs in accordance with an embodiment is shown. The method may be performed, for example, by a data source, a downstream consumer, an inference model manager, a LLM manager, and/or any other entity.

At operation 300, analytic data generated by a first LLM may be obtained based on at least an output generated by an inference model. Obtaining the analytic data may include: (i) feeding first ingest data into the first LLM, (ii) obtaining, as output from the first LLM, the analytic data, and/or (iii) other methods. The first ingest data may include: (i) inference model ingest data used by the inference model to generate the output, (ii) the output, (iii) a set of queries including questions to be answered by the first LLM, and/or (iv) other data.

Feeding the first ingest data into the first LLM may include: (i) obtaining the first ingest data, (ii) providing the first ingest data to the first LLM as input for the first LLM, and/or (iii) other methods.

Obtaining the analytic data as output from the first LLM may include: (i) reading the analytic data from storage, the analytic data being automatically stored following generation by the first LLM, (ii) obtaining the analytic data from another entity responsible for operating the first LLM, and/or (iii) other methods.

At operation 302, one or more questions generated by a second LLM may be obtained using at least the analytic data and a set of question generation templates, the one or more questions being usable to interpret the output. Obtaining the one or more questions may include: (i) reading the one or more questions from storage, (ii) receiving the one or more questions in the form of a message from another entity (e.g., via a transmission over a communication system), (iii) generating the one or more questions, and/or (iv) other methods.

Generating the one or more questions may include: (i) feeding the analytic data into the second LLM, (ii) obtaining the one or more questions as an output from the second LLM, and/or (iii) other methods.

At operation 304, the one or more questions may be provided to a downstream consumer for use in interpreting the output. Providing the one or more questions to the downstream consumer may include: (i) storing the one or more questions in storage for subsequent retrieval by the downstream consumer and/or an intermediary entity, (ii) transmitting the one or more questions to the downstream consumer via a communication system, the one or more questions being encapsulated in a data structure, and/or (iii) other methods.

The method may end following operation 304.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of interpreting an output generated by an inference model, the method comprising:
obtaining, based on at least the output, analytic data generated by a first large language model (LLM), the analytic data comprising:
leading indicators from ingest data used by the inference model to generate the output; and/or
emerging trends from the ingest data used by the inference model to identify the leading indicators;
obtaining, using at least the analytic data and a set of question generation templates, one or more questions generated by a second LLM, the one or more questions being usable to interpret the output; and
providing the one or more questions to a downstream consumer for use in interpreting the output.

2. The method of claim 1, wherein obtaining the analytic data comprises:
feeding first ingest data into the first LLM, the first ingest data comprising:
inference model ingest data used by the inference model to generate the output;
the output; and
a set of queries comprising questions to be answered by the first LLM, the questions being based on the inference model ingest data and the output; and
obtaining, as output from the first LLM, the analytic data.

3. The method of claim 2, wherein the leading indicators are based on a first query of the set of the queries and the emerging trends are based on a second query of the set of the queries.

4. The method of claim 3, wherein the first query and the second query are keyed to a portion of the output.

5. The method of claim 4, wherein the output comprises a prediction for a condition impacting a business at a future point in time.

6. The method of claim 5, wherein the condition impacting the business at the future point in time is a change in availability of supply of a product from a supplier.

7. The method of claim 6, wherein a leading indicator of the leading indicators is revenue of the supplier at the future point in time.

8. The method of claim 7, wherein an emerging trend of the emerging trends is a change in the revenue of the supplier at the future point in time.

9. The method of claim 2, wherein the questions are usable to search data sources from which the inference model ingest data was obtained to identify additional data usable to establish a level of confidence in the output.

10. The method of claim 1, wherein a first question generation template of the set of the question generation templates is keyed to a first portion of the analytic data, the first portion of the analytic data comprising an indicator of the indicators and an emerging trend of the emerging trends.

11. The method of claim 10, wherein the first question generation template prompts the second LLM to generate a question usable to identify facts to establish a causal relationship between a portion of the output and the first portion of the analytic data.

12. A non-transitory machine-readable medium having instructions stored therein, which when executed by a processor, cause the processor to perform operations for interpreting an output generated by an inference model, the operations comprising:
obtaining, based on at least the output, analytic data generated by a first large language model (LLM), the analytic data comprising:
leading indicators from ingest data used by the inference model to generate the output; and
emerging trends from the ingest data used by the inference model to identify the leading indicators;
obtaining, using at least the analytic data and a set of question generation templates, one or more questions generated by a second LLM, the one or more questions being usable to interpret the output; and
providing the one or more questions to a downstream consumer for use in interpreting the output.

13. The non-transitory machine-readable medium of claim 12, wherein obtaining the analytic data comprises:
feeding first ingest data into the first LLM, the first ingest data comprising:
inference model ingest data used by the inference model to generate the output;
the output; and
a set of queries comprising questions to be answered by the first LLM, the questions being based on the inference model ingest data and the output; and
obtaining, as output from the first LLM, the analytic data.

14. The non-transitory machine-readable medium of claim 13, wherein the leading indicators are based on a first query of the set of the queries and the emerging trends are based on a second query of the set of the queries.

15. The non-transitory machine-readable medium of claim 14, wherein the first query and the second query are keyed to a portion of the output.

16. The non-transitory machine-readable medium of claim 15, wherein the output comprises a prediction for a condition impacting a business at a future point in time.

17. A data processing system, comprising:
a processor; and
a memory coupled to the processor to store instructions, which when executed by the processor, cause the processor to perform operations for interpreting an output generated by an inference model, the operations comprising:
obtaining, based on at least the output, analytic data generated by a first large language model (LLM), the analytic data comprising:
leading indicators from ingest data used by the inference model to generate the output; and
emerging trends from the ingest data used by the inference model to identify the leading indicators;
obtaining, using at least the analytic data and a set of question generation templates, one or more questions generated by a second LLM, the one or more questions being usable to interpret the output; and
providing the one or more questions to a downstream consumer for use in interpreting the output.

18. The data processing system of claim 17, wherein obtaining the analytic data comprises:
feeding first ingest data into the first LLM, the first ingest data comprising:
inference model ingest data used by the inference model to generate the output;
the output; and
a set of queries comprising questions to be answered by the first LLM, the questions being based on the inference model ingest data and the output; and
obtaining, as output from the first LLM, the analytic data.

19. The data processing system of claim 18, wherein the leading indicators are based on a first query of the set of the queries and the emerging trends are based on a second query of the set of the queries.

20. The data processing system of claim 19, wherein the first query and the second query are keyed to a portion of the output.
